(19) United States
(12) Patent Application Publication
(10) Pub. No.: US 2026/0281659 A1
(43) Pub. Date: Sep. 17, 2026

(54) SYSTEM AND METHOD FOR CLUSTERING END USERS TO SELECT AND DELIVER A NOTIFICATION TO MOBILE DEVICE

(71) Applicant: Digital Factory Technologies, Inc., Cincinnati, OH (US)

(72) Inventors: Lawrence Griffith, Calument City, IL (US); Walid Johnson, Chicago, IL (US)

(21) Appl. No.: 19/547,294

(22) Filed: Feb. 23, 2026

Related U.S. Application Data
(63) Continuation-in-part of application No. 18/601,635, filed on Mar. 11, 2024, now Pat. No. 12,563,362.
Application No. 18/601,635 is a continuation of application No. 17/329,995, filed on May 25, 2021, now Pat. No. 11,930,421.

(51) Int. Cl. H04W 4/021; G06N 7/01; G06Q 30/0207; H04W 4/02

(52) U.S. Cl. CPC H04W 4/021; G06Q 30/0207; H04W 4/027; G06N 7/01

(57) ABSTRACT

A system configured to deliver notifications and content attributes associated with a fence for a geographic area, by collecting device sensor signals from a mobile computing device within a geofenced venue boundary, extracting behavioral features across multiple signal dimensions, and applying a trained classification model to produce a probability distribution across a plurality of intent persona categories. An intent quality coefficient is combined with dwell duration and contextual adjustment factors to produce a composite score. The system further provides a pre-entry intent prediction capability that analyzes inertial sensor patterns prior to venue boundary crossing to generate a pre-entry engagement probability. The invention also detects and excludes non-customer visitors, including employees and service providers, through behavioral pattern recognition. Consumers with high probability of engagement are delivered a notification based on the conversion probability.

### CROSS REFERENCE TO RELATED APPLICATIONS

This application is a continuation in part of U.S. patent application Ser. No. 18/601,635, filed Mar. 11, 2024 and issued as U.S. Pat. No. 12,563,362 on Feb. 24, 2026, which is a continuation of U.S. patent application Ser. No. 17/329,995, filed May 25, 2021 and issued as U.S. Pat. No. 11,930,421 on Mar. 12, 2024, which is a continuation of U.S. patent application Ser. No. 16/555,600, filed Aug. 29, 2019 and issued as U.S. Pat. No. 11,044,572 on Jun. 22, 2021. Each of these are incorporated herein by reference in their entirety.

### TECHNICAL FIELD

This disclosure relates to a system and method for clustering end users to deliver a notification to an end user's mobile device. More specifically, this disclosure relates to a system and method for clustering end users to select and deliver a notification to an end user's mobile device.

### BACKGROUND

Notifications or promotions are effective tools to pique consumers' interest in a product or service. The notification can include a coupon, discount, sample give away, or some other promotional offer to incentivize the consumer to try the product or service with the expectation that the consumer will continue to use the product or service afterwards. To maximize the effectiveness of a notification, the notification needs to be distributed to a consumer who is likely to convert on the offer in the notification. Furthermore, the notification needs to be distributed at the right time and at the right location. A general and broad distribution of notifications may overwhelm the consumer causing the consumer to ignore all notifications Even if the consumer receives a notification that is of interest to him or her but the distribution did not take into account of the location of the consumer, the consumer will need to make an effort to travel to a location that accepts the offer in the notification or remember that he or she has that notification the next time the consumer passes by a facility that accepts the offer in the notification. This inconvenience of traveling to a location that accepts the offer in the notification or remembering that he or she has the notification greatly reduces the chance that the end user will convert the offer in the notification.

Mere presence at a location has been used in the prior art to identify consumers likely to convert an offer, but mere presence alone does not reflect or capture the intention of a consumer with regard to that location, and specifically whether the consumer is evidencing intent to remain at that location or potentially convert offers if made by merchants at or near that location. Mere presence could indicate waiting for a rideshare or pickup, making a delivery or working for an employer near that location, other non-consumption activity. It would be advantageous to direct offers to those consumers showing intention for consumption.

Furthermore, it would be advantageous for a marketer to know the effectiveness of a notification. This information allows a marketer to decide whether to run a similar notification in the future, abandon such notification all together, or to modify the notification with the expectation that a modified notification can be more effective A break down on the effectiveness of a notification by a specific subgroup of end users would also help the marketer to understand how best to target the subgroup of end users.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a system comprising one or more memory devices storing programing instructions and one or more processors configured to execute the program instructions to cause the system to perform operations. The programing instructions comprise: receiving a fence defined by a first user, the fence includes an area having a geographic location, a plurality of notifications and their content attributes are associated with the fence.

Direction of notifications to consumers may involve receiving location and speed from a mobile device of a second user; determining the mobile device of the second user is stationary for a predetermined dwell time, and identifying a location attribute for the location of mobile device of the second user; associating the location attribute with the second user; aggregating a plurality of location attributes associated with the second user; determining an audience profile and audience profile attributes for the second user based on the aggregated location attributes for the second user; detecting that the second user has crossed into an area defined by the fence; and in response to detecting the second user crossing the fence: determining a conversion probability based on content attributes of the notifications associated with the fence and audience profile attributes of the audience profile associated with the second user; selecting a notification based the conversion probability; and causing the selected notification to be displayed on the mobile device of the second user.

In one embodiment, the method further comprises: (a) collecting device signals from a mobile computing device present within a geofenced venue boundary; (b) extracting a plurality of behavioral features from the collected signals across multiple signal dimensions; (c) classifying the visitor into one of a plurality of intent persona categories based on the extracted behavioral features using a trained machine learning model; (d) determining one or more contextual multiplier factors based on the nature of the engagement, the characteristics of the venue, and temporal relevance; and (e) computing a composite score by combining the raw dwell duration with the intent classification output and the contextual multiplier factors.

The invention further provides a method for predicting visitor engagement probability at a venue by applying a machine learning model to inertial sensor patterns from the mobile computing device, including accelerometer, gyroscope, and magnetometer data, to detect boundary crossing intent and generate a pre-entry engagement probability score. This pre-entry prediction is integrated with the post-entry behavioral classification to provide a continuous intent assessment spanning the full visitor lifecycle from approach through departure.

The invention further provides a method for identifying and excluding non-customer visitors, including employees and service providers, from customer-facing analytics through behavioral pattern recognition, thereby improving the accuracy of downstream applications.

Also disclosed is a method of delivering notifications to a mobile device. The method comprising the steps of: receiving a fence defined by a first user, the fence includes an area having a geographic location, a plurality of notifications and their content attributes are associated with the fence; receiving location and speed from a mobile device of a second user; determining the mobile device of the second user is stationary for a predetermine amount of time; identifying a location attribute for the location of mobile device of the second user; associating the location attribute with the second user; aggregating a plurality of location attributes associated with the second user; determining an audience profile and audience profile attributes for the second user based on the aggregated location attributes for the second user; detecting that the second user has crossed into an area defined by the fence, determining a conversion probability based on content attributes of the notifications associated with the fence and audience profile attributes of the audience profile associated with the second user; selecting a notification based the conversion probability; and causing the selected notification to be displayed on the mobile device of the second user.

Also disclosed is a non-transitory computer-readable storage medium having machine instructions stored therein. The instructions being executable by a processor to cause the processor to: receive a fence defined by a first user, the fence includes an area having a geographic location, a plurality of notifications and their content attributes are associated with the fence, receive location and speed from a mobile device of a second user; determine the mobile device of the second user is stationary for a predetermine amount of time; identify a location attribute for the location of mobile device of the second user; associate the location attribute with the second user; aggregate a plurality of location attributes associated with the second user; determine an audience profile and audience profile attributes for the second user based on the aggregated location attributes for the second user; detect that the second user has crossed into an area defined by the fence; determine a conversion probability based on content attributes of the notifications associated with the fence and audience profile attributes of the audience profile associated with the second user; select a notification based the conversion probability, and cause the selected notification to be displayed on the mobile device of the second user.

Various implementations described in the present disclosure may include additional systems, methods, features, and advantages, which may not necessarily be expressly disclosed herein but will be apparent to one of ordinary skill in the art upon examination of the following detailed description and accompanying drawings It is intended that all such systems, methods, features, and advantages be included within the present disclosure and protected by the accompanying claims.

### BRIEF DESCRIPTION OF THE DRAWINGS

FIG. 1 is a schematic of a mobile device of an end user, a personal computer of a marketer, and a system for clustering end users and selecting and delivering a notification to the mobile device.

FIGS. 2A and 2B illustrate a method for creating a microfence.

FIGS. 3A, 3B, and 3C illustrate a method for placing an end user into an audience profile, Kim.

FIGS. 4A and 4B illustrate a method for selecting and delivering a notification to an end user's mobile device.

FIGS. 5A and 5B illustrate screen shots of a dashboard showing locations of existing microfences and for receiving inputs to add a new microfence, edit an existing microfence, or delete an existing microfence.

FIG. 6 illustrates a screen shot of a dashboard showing attributes for the audience profile, Kim.

FIG. 7 illustrates a screen shot of a dashboard showing a plurality of notifications and performance of the highlighted notification.

FIG. 8 illustrates a screen shot of a dashboard showing the statistics and performance for the audience profile.

FIG. 9 illustrates a mobile device displaying a notification selected by the system.

FIG. 10 illustrates IWDS Computation Engine Pipeline according to the principles of the present invention, which includes a four-layer sequential pipeline: Signal Collection Layer, Feature Engineering Layer, Intent Classification Layer, and Score Computation Layer, with their respective outputs.

FIG. 11 illustrates the IWDS Computation Method as a flowchart from signal receipt through feature extraction, classification, component factor determination, and final score computation.

FIG. 12 illustrates Behavioral Signal Dimensions used in accordance with an embodiment of the invention including four principal signal dimensions of Movement Patterns, Temporal Patterns, Spatial Behavior, and Device Characteristics and their relationship to the behavioral feature vector.

FIG. 13 illustrates the Intent Classification Process flow from behavioral feature vector through model inference to persona probability distribution to Intent Quality Coefficient.

FIG. 14 illustrates the end-to-end System Architecture of an embodiment in accordance with principles of the present invention including the Client Layer, Ingestion Layer, Processing Engine, Data Layer, and API Layer.

FIG. 15 illustrates the Employee Detection Decision Flow process for identifying and excluding non-customer visitors based on behavioral pattern analysis.

FIG. 16 illustrates the IWDS vs Raw Dwell Ranking Comparison demonstrating the corrections produced by the IWDS method and inverted ranking produced by raw dwell time, assigning highest value to high-intent visitors and excluding non-customer visits.

FIG. 17 illustrates the Pre-Entry Intent Prediction Flow the two-layer intent assessment architecture including Layer 1 which analyzes inertial sensor patterns during the approach phase to predict engagement probability and Layer which 2 performs post-entry behavioral classification and composite scoring.

### DETAILED DESCRIPTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems This applies to all aspects of this application including, but not limited to, steps in disclosed methods. Thus, if there are a variety of additional steps that can be performed it is understood that each of these additional steps can be performed with any specific aspect or combination of aspects of the disclosed methods.

### Environment for Delivering a Notification to Mobile Device

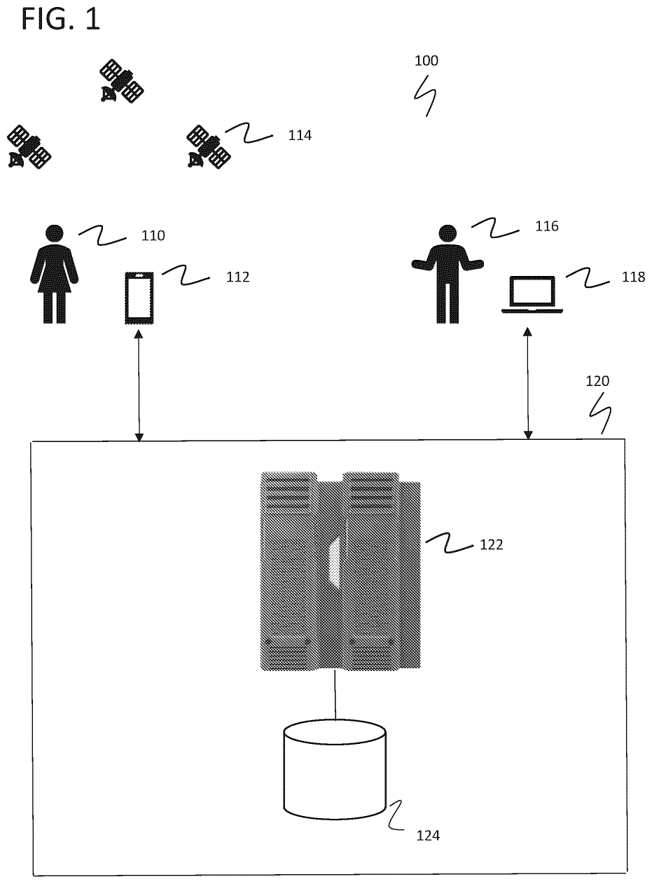

FIG. 1 illustrates an environment 100 of one embodiment of a system 120 for clustering end users and delivering a notification to an end user's mobile device. In one embodiment, the system 120 is accessible by an end user 110, who may be a subscriber to an appl associated with the system 120, through two-way communications with the user's mobile device 112. The end user's mobile device 112 is capable of tracking the mobile device's location through triangulation of satellites (GPS) 114 or through triangulation of cellar towers The user's mobile device 112 is also capable of tracking the mobile device's speed via an accelerometer and/or changes in location over time through triangulation. It is assumed that the end user 110 is carrying the mobile device 112 or keeps the mobile device close to him or her, such as in the vehicle that the end user is driving. Hence, it can be assumed that the location and speed of the end user's mobile device 112 is approximately the same as the location and speed of the end user 110. Therefore, the location of the end user's mobile device 112 can be used interchangeably with the location of the end user 110 and the speed of the end user's mobile device 112 can be used interchangeably with the speed of the end user 110.

FIG. 1 further illustrates one embodiment of a system 120 accessible by a marketer or an administrator (hereinafter “marketer”) 116, involved in marketing products or services to consumers, through two-way communications with the marketer's computer 118 or some other device such as a tablet or a mobile device. The marketer's computer 118 includes an output component, such as a monitor, capable of displaying content from the system 120 and at least one input component, such as a keyboard, mouse, or touch screen, capable of sending requests and inputs to the system 120.

In one embodiment, the system 120 is functionally controlled by a control unit. The control unit includes at least one specially configured processor and at least one controller configured to operate with at least one memory device and at least one data storage device (collectively referred to herein as “memory device”) 124.

In one embodiment, control unit includes at least one specially configured processor or central processing unit (CPU). In one embodiment, specially configured processor includes arithmetic logic units and math co-processors also known as floating point units. In one embodiment, specially configured processor includes registers for holding instructions or other data, and cache memory for storing data for faster operation thereupon. In one embodiment, specially configured processor may be a multi-core processor that includes two or more processors for enhanced performance, more efficient parallel processing, or other advantageous computing functions. In another embodiment, specially configured processor may be one or more processing devices such as microprocessor(s) or integrated circuit(s) and may include one or more controllers. It should be appreciated that in some embodiments, a general purpose processor could be programmed to perform the functions of specially configured processor.

A controller, in one embodiment, is a device or a software program that manages or directs the flow of data between two entities. Often, controllers are special purpose circuitry or software that solve a technical communications problem between different technology systems. In one embodiment, a controller functions as an interface between two systems while managing the communications between the systems. In another embodiment, a controller functions as an interface between a processor and a peripheral device and functions to control the peripheral device.

In FIG. 1, at least one specially configured processor and controller (collectively referred to herein as “processor”) 122 is configured to communicate with at least one memory device 124. In one embodiment, memory device 124 includes one or more memory structures for storing instructions and various types of data. Memory structures may include one or more random access memory units (RAMs) units, one or more read only memory units (ROMs), one or more flash memory units including solid state drives (SSDs), one or more electrically erasable/programmable read only memory units (EEPROMs).

It should be appreciated that in one embodiment, communication with a memory device by a processor encompasses the processor accessing the memory device, exchanging data with the memory device, or storing data to the memory device.

Memory device 124 may store all program code and operation data necessary for the operation of the system 120 described hereinbelow. In an alternative embodiment, code and operation data necessary for the operation of the system 120 may be store in a distributed manner such that some code is stored in the memory device 124 and other code is stored remotely from system 120. In one embodiment, the code and operation data necessary for the operation of the system includes, for example, basic input and output function data, instruction fetching data, bus and network communication protocol data, and like data.

In addition to the memory device 124 described above, in another embodiment, the code and operation data for the operation of the system described hereinbelow may be stored in removable cartridges or flash drives, a compact disk ROM, a digital versatile disk (DVD) optical storage technology, or suitable other fixed non-transitory storage mediums. In another embodiment, part or all of the code and operational data for operation of the system may be stored in a remote memory structure and be downloaded to the memory device 124 via a network connection.

In one embodiment, the system 120 may utilize any combination of memory devices such as random access memory devices (RAMS), unalterable memory devices (ROMs), and mass storage devices for securely storing and securely communicating the software components or code that facilitate operation and other functions of the system 120.

The subject matter and functional operations described in relation to FIG. 1 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

### System and Method for Creating Microfence

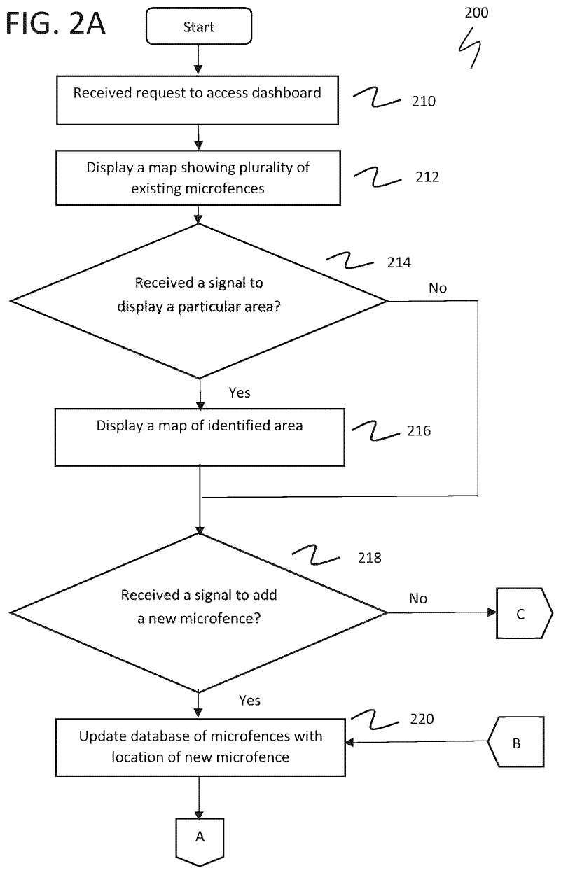

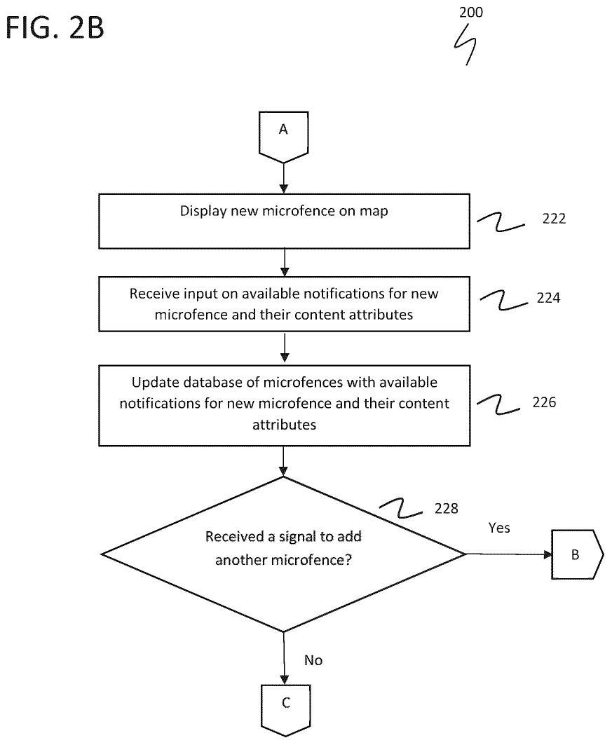

FIGS. 2A and 2B illustrate a flowchart of an example operation 200 of one embodiment of the system and method for creating a microfence.

In one embodiment, a processor 122 of the system 120 (shown in FIG. 1) is configured, via instructions stored in a memory device 124, to perform the operation 200. However, it should be appreciated that other suitable variations of operation 200 are possible. For example, in one embodiment, fewer or one or more additional blocks (not shown) may be employed in operation 200 of the system and method. In other embodiments, the blocks may be performed in any suitable order.

FIG. 2A illustrates one embodiment in which the system 120 receives a request from a computer 118 of a marketer 116 (shown in FIG. 1), to access a dashboard showing locations of existing microfences in accordance to block 210. The microfence can be a geographic area which the system 120 can be triggered to perform certain operations once a mobile device enters the microfence The microfence can be identified as a particular location (including but not limited to GPS coordinate, latitude and longitude, address, road intersection) and a given radius, such as ¼ mile from the location After the system receives a request to access a dashboard, in accordance to block 212, the system 120 causes the computer monitor 118 of the marketer 116 to display a map showing a plurality of existing microfences, if any, previously created by the marketer or other users having access to the dashboard. After viewing the originally displayed map, the marketer 116 may decide to zoom in or out to a particular area of interest. In the situation for which the system received a signal to display a particular area of interest, as illustrated in block 214, the system 120 causes the monitor to display a map of that particular area showing the microfences, if any, previously created by the marketer or other users having access to the dashboard, as illustrated in block 216.

After viewing the microfences saved in memory device 124 of the system 120, the marketer 116 may decide to add or create to a new microfence In the event that the system 120 received a signal from the marketer's computer to add a new microfence, as illustrated in block 218, the system 120 updates the database of microfences with the location and area of the new microfence as illustrated in block 220 and causes the marketer's monitor to display the new microfence on the map, as illustrated in block 222 via off page connector A in FIG. 2B.

In one embodiment, accordance to block 224, the system may receive inputs from the marketer to select, import, and/or create the notifications available for and to be associated with the new microfence, along with the content attributes associated with each notification. The notification includes one or more promotional offers (including but not limited to coupons, discounts, sample give away, and other offers) that are available to an end customer to redeem or convert. The system then updates database of microfences by saving the available notifications for the new microfence to the memory device 124, along with the content attributes for each notification as illustrated in block 226.

After creating a new microfence, the marketer may want to create another microfence. In the event that the processor 122 received a signal to add another microfence in accordance to block 226, the system updates the database of microfences in memory device 124 with location of the second new microfences and the process of operation 200 in accordance to blocks 220, 222, 224, 226, and 228 repeats until the processor 122 no longer receives a signal to add another microfence.

### System and Method for Placing End User Into an Audience Profile

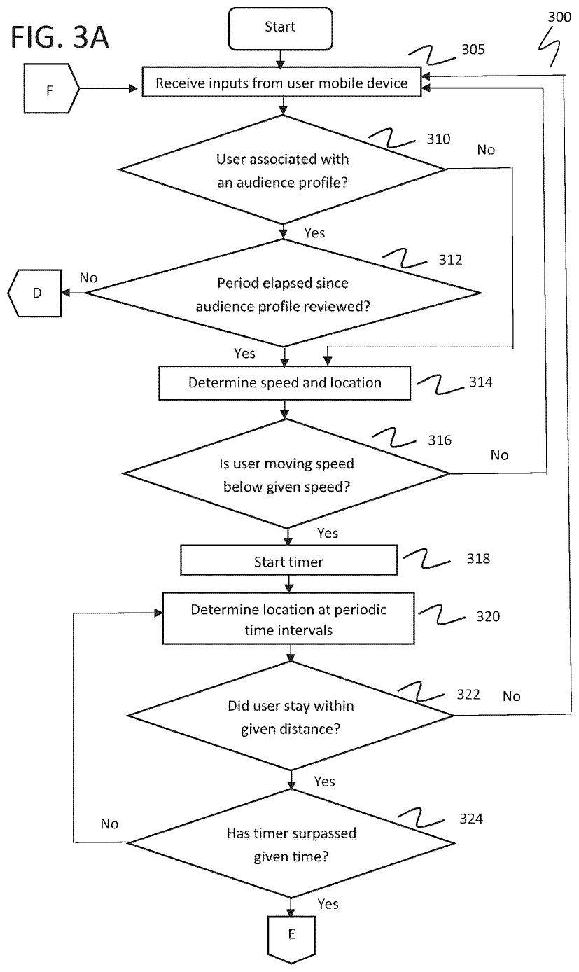

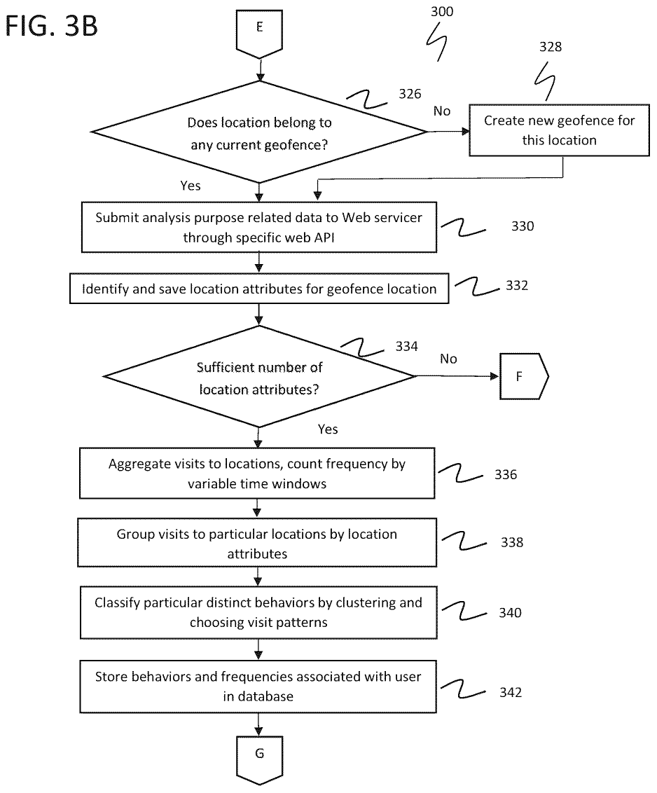

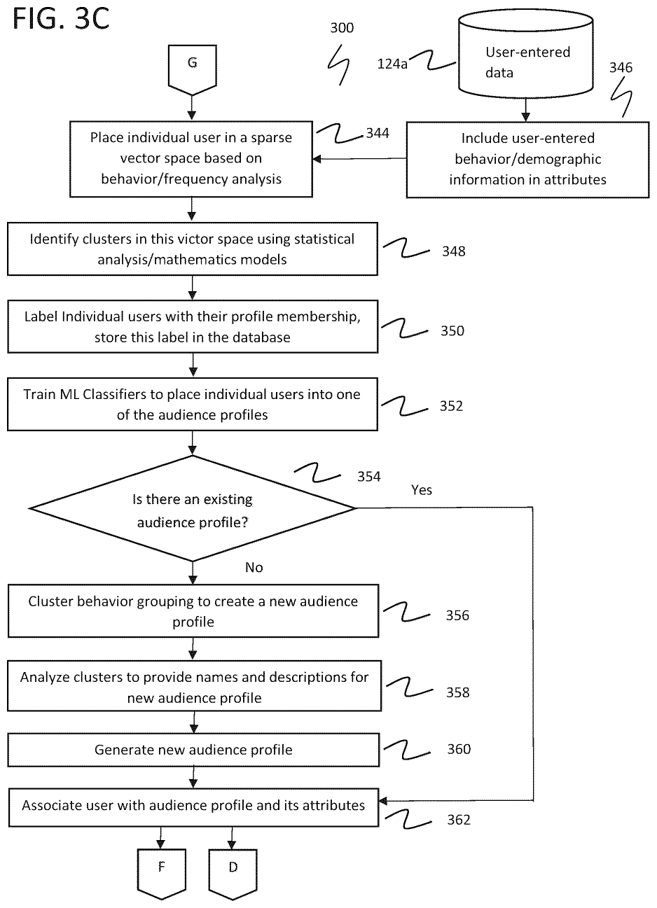

FIGS. 3A, 3B and 3C illustrate a flowchart of an example operation 300 of one embodiment of the system and method for placing an end user into an audience profile.

In one embodiment, a processor 122 of the system 120 (shown in FIG. 1) is configured, via instructions stored in a memory device 124, to perform the operation 300. However, it should be appreciated that other suitable variations of operation 300 are possible. For example, in one embodiment, fewer or one or more additional blocks (not shown) may be employed in operation 300 of the system and method. In other embodiments, the blocks may be performed in any suitable order.

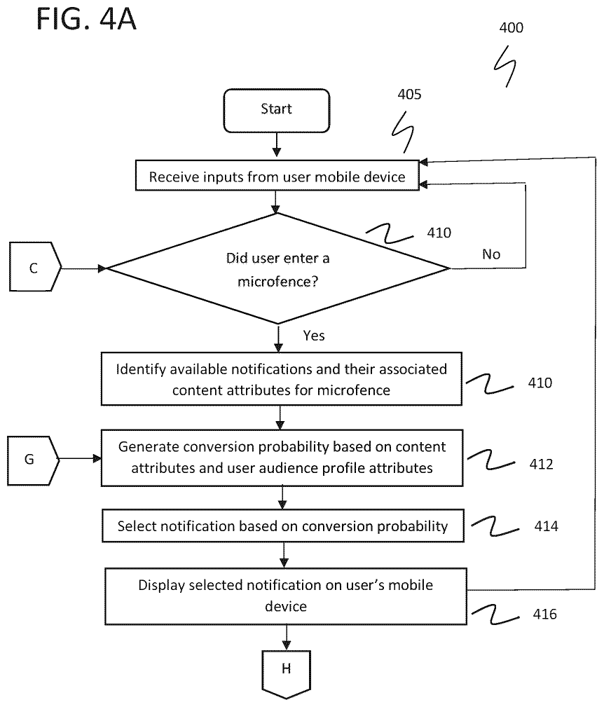

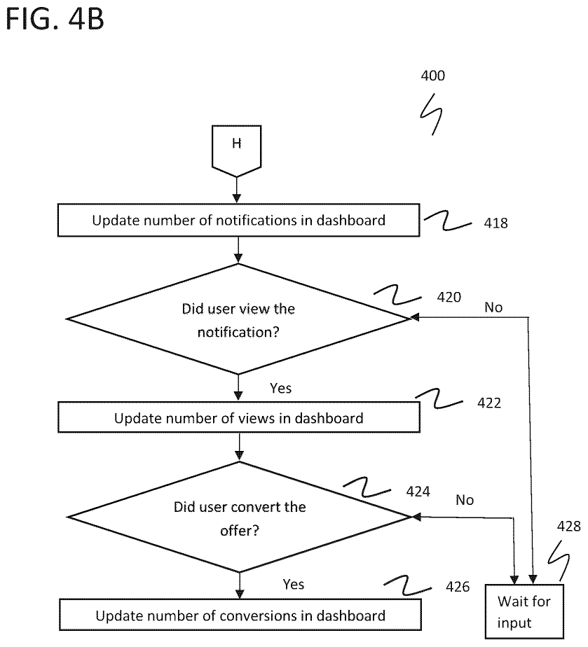

As indicted in block 305, the system 120 may receive inputs from a mobile device 112 of an end user 110 (shown in FIG. 1). The inputs include information to identify the end user and to determine the location and the speed of the mobile device 112. The system 120 uses the information received from the mobile device 112 to identify the user in order to determine if an audience profile has been associated with the end user in accordance to block 310. In one embodiment, if an audience profile has not been associated with the user, process of operation 300 continues to block 314 to determine the location and speed of the mobile device. If an audience profile has already been associated with the end user, the process of operation 300 continues to block 312 to determine if a predetermined time period, such as one month, has elapsed since the audience profile for the end user was last reviewed. In accordance to block 312, if the predetermined time period has elapsed since the audience profile for the end user was last reviewed, the system 120 reassesses whether the end user should be placed in a new audience profile by the process of operation 300 continuing to block 314 to determine the location and speed of the mobile device. If the predetermined time period has not elapsed since the audience profile for the end user was last reviewed, the end user will continue to be associated with that audience profile. The audience profile and its attributes can be used for other operations, such as “selecting and delivering a notification to mobile device” to be discussed below in association with FIGS. 4A and 4B, via off page connector D.

In one embodiment, if the mobile device 12 is moving at a speed below a given or predetermine speed (such as 5 m/s or another speed that was predetermined as an indicator that the end user has purposely stopped at a location); in accordance to block 314, the process of operation then proceed to determine whether the end user purposely stopped at a location (“stationary”) or whether the end user stopped unintentionally, such as waiting at a traffic light. If the mobile device is not moving below a given speed, the process of operation 300 then goes back to block 305 in which the system 120 may receive, from the mobile device 112, new information to determine the location and speed of the mobile device.

To determine if the end user is stationary, in one embodiment, the system may start a timer in accordance to block 318. After a periodic time interval has elapsed, such as one second, the system determines a new location of the mobile device as indicated by block 320. As indicated by block 322, after the periodic time interval has elapsed, if the location of the mobile device remains within a given distance, such as 10 meters, from the original location determined in block 314, the process of operation continues by determining another new location after a periodic time interval until the timer started in block 318 has surpassed a given or predetermined amount of time, such as twenty seconds, in accordance to block 324 During the time that the predetermined amount of time has not elapsed, if the location of the mobile device is beyond the given distance from the original location determined in block 314, it is assumed that the end user is not stationary and process of operation 300 goes back to block 305 in which the system 120 may receive from the mobile device 112 new information to determine the location and speed of the mobile device.

In one embodiment, after the timer has surpassed the predetermined amount of time and the mobile device remained within the given distance from the original location determined in block 314, the process of operation 300 continues to block 326 via off page connector E in FIG. 3B in which the system 120 then evaluates if the original location determined in block 314 belongs to any current geofence saved in its memory device 124. If the original location belongs to a current geofence saved in the system's memory device, the process of operation 300 continues to block 330. If the original coordinate does not belong to a current geofence saved in the system's memory device, a new geofence is created for this location in accordance to block 328 and then the process of operation 300 continues to block 330.

In one embodiment as shown in block 330, the system submits analysis purpose related data to the Web server through specific web API and then determines the location attributes of the geofence location and saves the location attribute in accordance to block 332. The location attribute can be the type of product or service provided at that location, such a fast food restaurant, a movie theater, a school, a hospital, etc. The identified location attribute is then saved in the memory device 124 of the system 120 as being associated with end user. In accordance to block 334, if a sufficient number of location attributes have been saved for the end user, the system aggregates the end user's visits to the different location attributes per time period (day, week, or month) in accordance to block 336. In one embodiment, the number of sufficient location attributes is at least a number that would be statistically significant to indicate the habit and behavior of the end user. If number of location attributes saved for the end use has not surpassed the sufficient number of location attributes, the process of operation 300 goes back to block 305 via off page connector F in FIG. 3A to continue identifying additional location attributes to associate with the end user.

In one embodiment, if a sufficient number of location attributes have been saved for the end user and the system aggregated the end user's visits to the different the location attributes, the system then group the end user's visits to particular locations by their location attributes, in accordance to block 338. The process of operation 300, then proceed to block 340 in which the system classifies particular distinct behaviors of the end user by taking into account the clustered and chosen visiting patterns of the end user. In accordance to block 342, these particular distinct behaviors and frequencies associated with the end user are then stored in a database.

The process of operation 300 continues to block 344 via off page connector Gin FIG. 3C in which the system 120 then places an identifier for the individual end user in a sparse vector space based on the end user's behavior/frequency analysis. In addition to behaviors based on the end user's aggregated visits to geofence locations, the end user's behaviors can also be derived from end user entered data. In one embodiment, during the app registration process, the end user may provide personal information about himself or herself, such as his or her preferences and demographics including but not limited to marital status, income range, profession, etc. These user-entered data can be stored in a memory device 124a. In accordance to block 346, this user-entered behavior and demographic information can also be used to place the individual end user's identifier in a sparse vector space, in accordance to block 344. The process of operation, in block 348, then identifies clusters in this victor space using statistical analysis/mathematics models. The system 120, in accordance to block 350, then label individual end users with their profile membership and store this label in the database. During this process, a ML Classifier, or other machine learning engine, is trained to place individual users into one of the audience profiles in accordance to block 352. During this process, in accordance to block 354, the system also determines if there is an existing audience profile having location attributes visits that closely matches the end user's aggregated visits to the different location attributes. The audience profile is a hypothetical person that represents a group or cluster of end users having similar attributes. The use of an audience profile allows the system 120 to quickly and efficiently identify the characteristics of an end user by his or her audience profile when determining the spending habits of the end user and hence the probability of the end user converting an offer. In other embodiments, if a sufficient number of location attributes have been saved for the end user and the system aggregated the end user's visits to the different location attributes, the system 120 then determines if there is an existing audience profile that closely matches the aggregated location attributes visits, attributes provided by the end user (such as the user-entered data stored in memory device 124a) and/or other attributes collected about the user (such as from public information about the end user available on the internee).

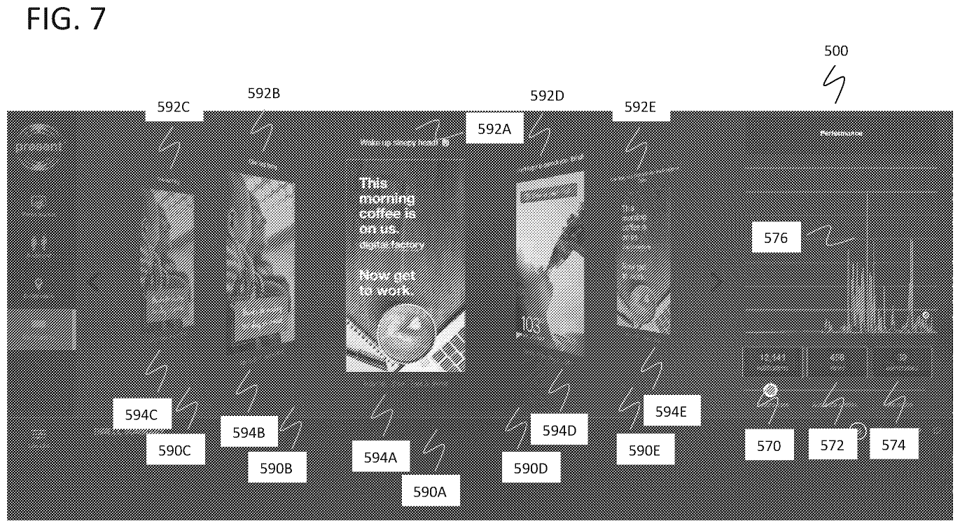

If there is an existing audience profile, the end user is associated with that audience profile, along with the audience profile attributes for that audience profile, in accordance to block 362. The audience profile attributes include the behavior frequency for the audience profile, such as the audience profile's app usage, the audience profile's route commutes, the audience profile's visits to fast food restaurants by car, the audience profile's visits to fast food restaurants by bus, the audience profile's visit to clothing stores, etc. Examples of audience profile attributes will be further discussed in association with FIG. 7. If there is not an existing audience profile which closely matches the end user's aggregated visits to the different location attributes, the system clusters behavior grouping based on behavior frequency attributes, inferred home/work location categories, etc. to create a new audience profile in accordance to block 356. While blocks 350, 352 and 354 are shown in FIG. 3C as sequential steps, those skilled in the relevant art will recognize and appreciate that these steps can performed by the system 120 simultaneously, interchangeably, or in a different order.

In one embodiment, in accordance to block 358, a marketer further analyzes the cluster to provide a name and description for the new audience profile. The system 120 generates and saves the new audience profile in its memory device 124 in accordance to block 360 and the end user is associated with that audience profile and the associated audience profile attributes, in accordance to block 362. The audience profile associated with end user and its attributes can be used for other operations, such as “selecting and delivering a notification to mobile device” to be discussed below in association with FIGS. 4A and 4B, via off page connector D. The process of operation 300 goes back to block 305 via off page connector F in FIG. 3A to continue identifying additional location attributes to associate with the end user.

### System and Method for Selecting and Delivering a Notification to Mobile Device

FIGS. 4A and 4B illustrate a flowchart of an example operation 400 of one embodiment of the system and method for selecting and delivering a notification to an end user's mobile device.

In one embodiment, a processor 122 of the system 120 (shown in FIG. 1) is configured, via instructions stored in a memory device 124, to perform the operation 400. However, it should be appreciated that other suitable variations of operation 400 are possible. For example, in one embodiment, fewer or one or more additional blocks (not shown) may be employed in operation 400 of the system and method. In other embodiments, the blocks may be performed in any suitable order.

As indicted in block 405, the system 120 may receive inputs from a mobile device 112 of an end user 110 (shown in FIG. 1). The inputs include information to identify the end user and to determine the location of the mobile device 112. In accordance to block 410, the system then evaluates whether the mobile device 112 and the end user 110 have entered a microfence that was previously created by a marketer 116 through the process of operation 200 illustrated in FIGS. 2A and 2B via off page connector C. If the end user did not enter a microfence, the process of operation 400 goes back to block 405 to receive new inputs, including the end user's new location from the end user's mobile device If the end user did enter a microfence, in accordance to block 410, the system identifies or retrieves from the memory device 124 the notifications available for and associated with that microfence along with the associated content attributes for each notification. The notification includes one or more promotional offers (including but not limited to coupons, discounts, sample give away, and other offers) that are available to an end customer to redeem or convert. In one embodiment, the content attributes can be the goods and services associated with the offers provided in the notification. In one embodiment, content attributes can include but not limited to fast food, cafe, alcoholic beverage, coffee, soft drink, bus travel, train travel, clothing, and other products or services associated with the offer provided in a notification.

In accordance to one embodiment, based on the audience profile attributes for the audience profile that was previously associated with the end user through the process of operation 300 illustrated in FIGS. 3A, 3B and 3C via off page connector D and the content attributes associated with notifications available for the geofence retrieved in block 410, the system 120 generates a conversion probability for the end user in accordance to block 412. In one embodiment, the conversion probability represents the likelihood or probability that the end user will convert the offer provided in a notification In accordance to block 414, the system 120 then selects a notification for display to the end user based on the generated conversion probability. The selected notification can be the notification, from the plurality of notifications available for the microfence, that the end user is most likely to convert the offer provided in the notification. Once the system selects a notification based the generated conversion probability, the system causes the end user's mobile device to display the selected notification on the user's mobile device in accordance to block 416. The process of operation continues to repeat to block 405 by receiving new locations and determining if the user has entered another microfence.

### Dashboard

In accordance to one embodiment, the process of operation 400 also provides information to the marketer 116 by displaying a dashboard with the number of notifications sent to end users, the number of end users who viewed the notifications and the number of offers that the end users converted. The information displayed on the dashboard assists the marketer to assess the success of the marketing campaign for which the notification is created. After the selected notification has been selected and displayed on the user's mobile device, in one embodiment, the process of operation 400 continues to block 418 via off page connector H in FIG. 4B in which the system 120 updates in its memory device with the number of notifications sent to end users and causes the new number of notifications sent end users to be displayed on a dashboard. The process of operation 400 then continues to block 420 in which the system 120 determines if the end user viewed the notification. In one embodiment, if the system received a signal from the mobile device 112 indicating that the end user 110 viewed the notification, the system updates the number of views by end users in its memory device and causes the new number of views by end user to be displayed on the dashboard in accordance to block 422. If a signal is not received from the mobile device indicating that the end user viewed the notification, it is assumed that the notification has not yet been viewed by the end user. In one embodiment, if a signal has not been received from the mobile device indicating that the end user viewed the notification, the system continues to wait indefinitely for a signal that the end user viewed the notification, in accordance to block 428. In other embodiments, if a signal has not been received from the mobile device indicating that the end user viewed the notification, the system continues to wait until the promotion end date for the offer provided in the notification. If the end customer viewed the notification, the process of operation 400 then continues to block 424 in which the system then determines if the end user converted the offer provided in the notification. In one embodiment, if a signal has been received from the offer service or product provider that the end user converted or redeemed the offer, the system updates in its memory device with the number of conversions by end users and causes the new number of conversions by end user to be displayed on the dashboard in accordance to block 426. If a signal has not been received from the service or product provider indicating that the end user converted the offer provided in the notification, it is assumed that the offer has not yet been converted by the end user. In one embodiment, if a signal has not been received from the service or product provider indicating that the end user converted the offer, the system continues to wait indefinitely from the service or product provider for an input that the end user converted the notification, in accordance to block 428. In other embodiments, if a signal has not been received from the service or product provider indicating that the end user converted the offer, the system continues to wait until the promotion end date for the offer provided in the notification.

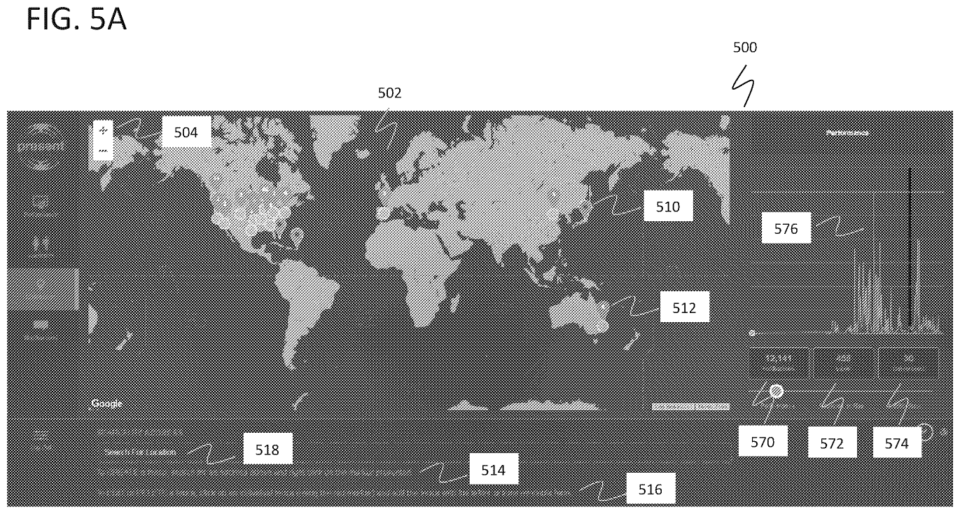

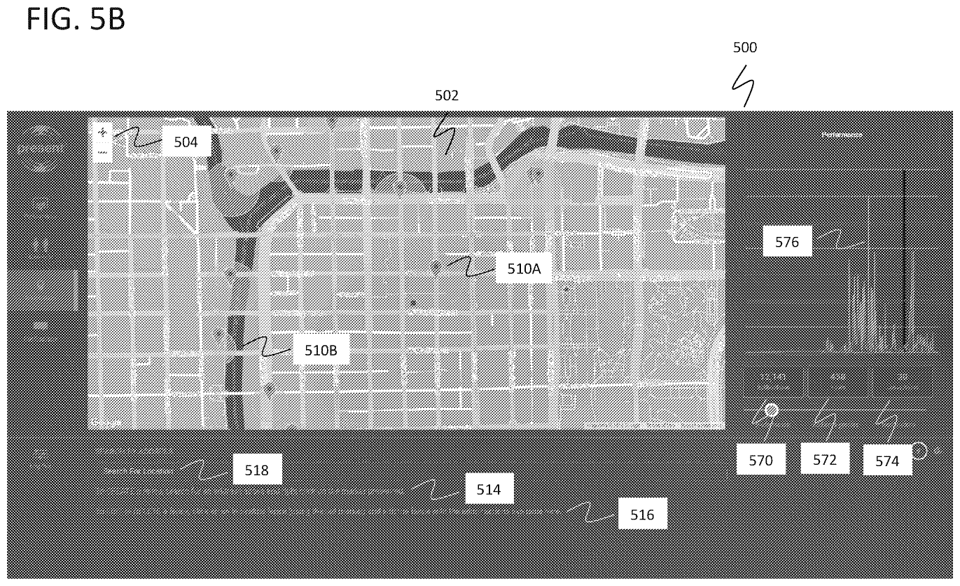

FIGS. 5A-B, and 6-8 illustrate screen shots of the dashboard available to be displayed to the marketer. The dashboard includes several information areas and input areas/buttons/icons These information areas and input areas/buttons/icons are illustrated in a particular arrangement, but may be arranged in any suitable manner in different embodiment. In some embodiments, the dashboard may include more or fewer information areas and input areas/buttons/icon than illustrated. In some other embodiments, the content of the information may be displayed as a table, a bar chart, pie chart, bar graph, or some other format.

FIG. 5A illustrates one embodiment of a dashboard showing locations of existing microfences and for receiving inputs to add or create a new microfence. The dashboard may be displayed on a computer monitor 118 of a marketer 116 illustrated in FIG. 1. FIG. 5A illustrates a dashboard 500 that includes a map 502 showing the locations of existing microfences 510 that were previously created by the marketer 116 or other user having access to the dashboard 500. In the event that multiple microfences are overlayed on the displayed map scale, a number 512 is displayed to represent the number of microfences located at that region. The dashboard displays the instructions 514 to create a fence and the instructions 516 to edit or delete a fence. The dashboard also provides an input area 518 to search for a location by GPS coordinate, latitude and longitude, address, or road intersection. Should the marketer desires to zoom in or zoom out of the map, the marketer can change the scale of the map by clicking the scale input button 504. Alternatively, the marketer can zoom in a particular region of the map by clicking a particular region on the map 502.

FIG. 5B illustrates the dashboard 500 in which the system 120 received an input from the marketer, either by clicking the scale input button or a particular region of the map, to zoom in a region of downtown Chicago. At this scale of the map, all the individual microfences 510 are visible. In one embodiment, each microfence 510 is identified by a central location (such as GPS coordinate, latitude and longitude, address, or road intersection) and a radius from the central location to define the border of the microfence. It should be noted that the radius from the central location does not need to be the same for all microfences For instance, the radius from the central location of microfence 510A is approximately one city block (approximately a quarter of a mile) whereas the radius from the central location of microfence 510B is approximately half a city block (approximately an eighth of a mile). In other embodiments, a microfence need not be defined by a central location and a radius from the central location, rather a microfence can be defined by a rectangle representing a city block or a nonuniform shape of a park. In addition to the system receiving inputs to define the location and border of a microfence, in one embodiment, the system can also receive inputs on the notifications that are available for the microfence in accordance to block 224 shown in FIG. 2B.

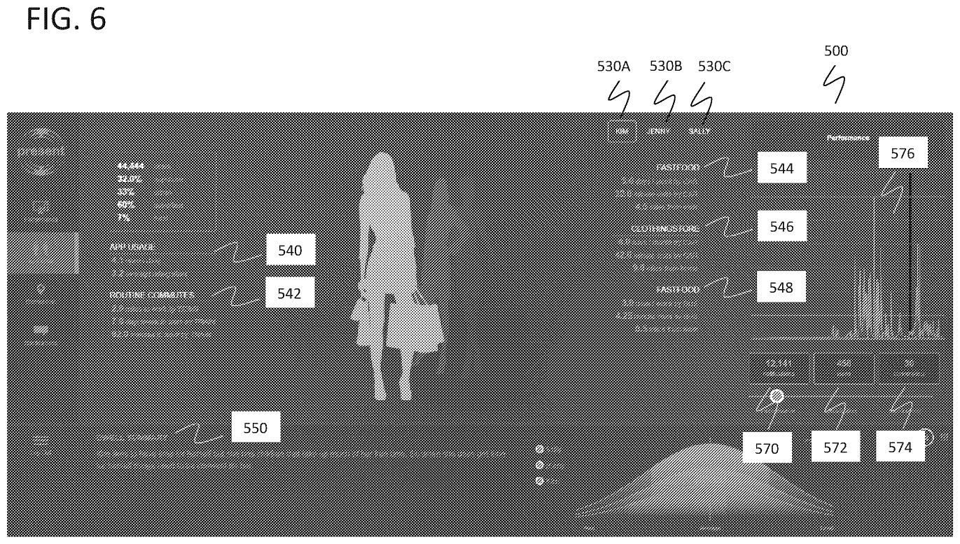

FIG. 6 illustrates one embodiment of the dashboard 500 displaying the attributes for the highlighted/selected audience profile, Kim 530A. Also shown are buttons for audience profiles, Jenny 530B and Sally 530C, although the buttons for these other audience profiles are not highlighted/selected in the dashboard. As previously discussed, Kim is not an actual person. Rather Kim is a hypothetical person that represents a group or cluster of end users having similar attributes. The use of an audience profile, such as Kim, allows the system to identify the habits or attributes of an end user quickly and effectively by grouping or clustering the end user with other end users having similar habits or attributes. In one embodiment, the illustrated dashboard 500 includes app usage 540 for Kim, routine commutes 542 for Kim, fast food visits by car 544 for Kim, clothing store visits by car 546 for Kim, and fast food visits by bus 548 for Kim. The illustrated dashboard 500 also includes a summary 550 for Kim displaying other attributes. In other embodiments, additional attributes for an audience profile can be determined and displayed, including but not limited to pregnancy, estimated income level, neighborhood type (suburban, rural, urban), religious beliefs, dining habits, exercise habits, education level, age/phase of life, and health problems. For the illustrated embodiment, should the marketer wish to view the attributes for one of the other audience profiles, the marketer can click on the button for Jenny 530B or Sally 530C. In other embodiments more or fewer audience profiles can be available in the dashboard 500.

FIG. 7 illustrates one embodiment of the dashboard 500 showing the notifications 590A-E available for a particular microfence. The dashboard 500 displays the notifications 590A-E that are available to the end users, the name 592A-E of each notification and the promotion date range 594A-E of each notification. As illustrated in FIG. 7, and also FIGS. 5A, 5B and 6, the performance of the highlighted notification 590A is displayed. For the highlighted notification 590A, the dashboard displays in display area 570 the number of notifications that this highlighted notification 590A had been sent to end users. In one embodiment, the number of notifications displayed in display area 570 is updated in the process of operation 400 in block 418 in FIG. 4B. The dashboard also displays in display area 572 the number of views of the highlighted notification 590A by end users and displays in the display area 574 the number of conversions of the offers provided in the highlighted notification 590A. In one embodiment, the number of views and the number of conversions displayed in display areas 572 and 574 are updated in the process of operation 400 in blocks 422 and 426 in FIG. 4B. The performance of the highlighted notification 590A can also be illustrated graphically by one or more graphs in display area 576 as shown in FIGS. 5A, 5B, 6 and 7.

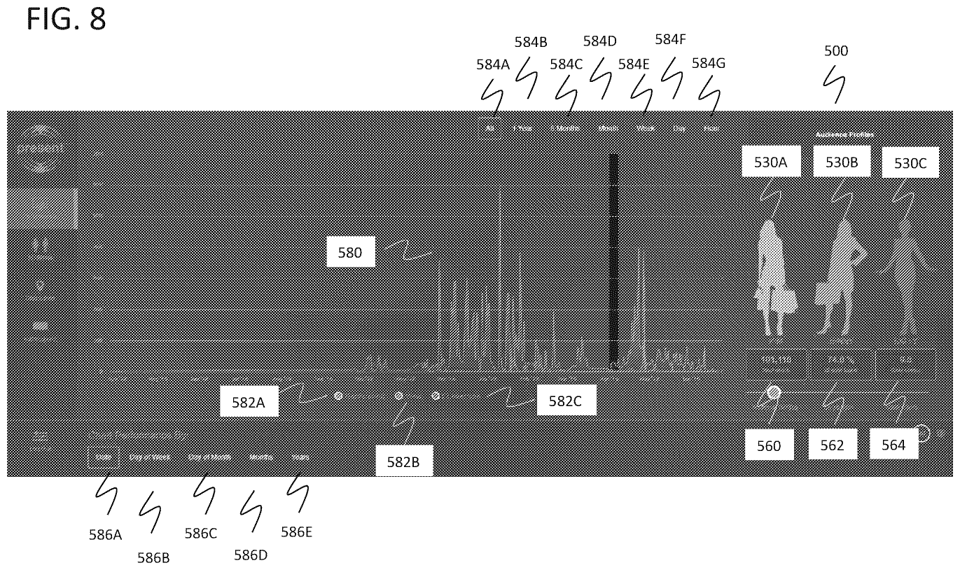

FIG. 8 illustrates one embodiment of the dashboard 500 displaying the statistic and performance for a particular audience profile 530 from the possible audience profiles, Kim 530A, Jenny 530B and Sally 530C. The illustrated dashboard 500 shows the statistics and performance for Kim 530A, the selected and highlighted audience profile. In one embodiment, the dashboard 500 displays in the display area 560 the total number of end users that are associated with the Kim audience profile 530A. The dashboard 500 also displays in the display area 562 the percentage of total end users that are associated with the Kim audience profile and displays in the display area 564 the average number of new end users that are being associated with the Kim audience profile each day.

In addition to providing the statistics for the Kim audience profile, in one embodiment, the dashboard displays one or more graphs 580 showing the performance for the Kim audience profile. The graphs 580 illustrated in FIG. 8 include a graph showing the number of notifications 582A sent to end users associated with the Kim audience profile. The graphs illustrated in FIG. 8 also include a graph showing the number of views 582B made by end users associated with the Kim audience profile and a graph showing the number of offer conversions 582C made by end users associated with the Kim audience profile in response to viewing the notifications. The performance graphs 580 can be for all time periods, as illustrated in FIG. 8, by selecting the “All” button 584A. Alternatively, the displayed time period for the graphs 580 can be changed by selecting the “1 Year” button 530B, the “6 Months” button 530C, the Month” button 530D, the “Week” button 530E, the “Day” button 560F, or the “Hour” button 560G. The performance graphs 580 can be displayed in increments of each date, as illustrated in FIG. 8, by selecting the “Date” button 586A. Alternatively, the graphs 580 can be displayed in other increments by selecting the “Day of Week” button 586B, the “Day of Month” button 586C, the “Months” button 586D, or the “Years” button 586E.

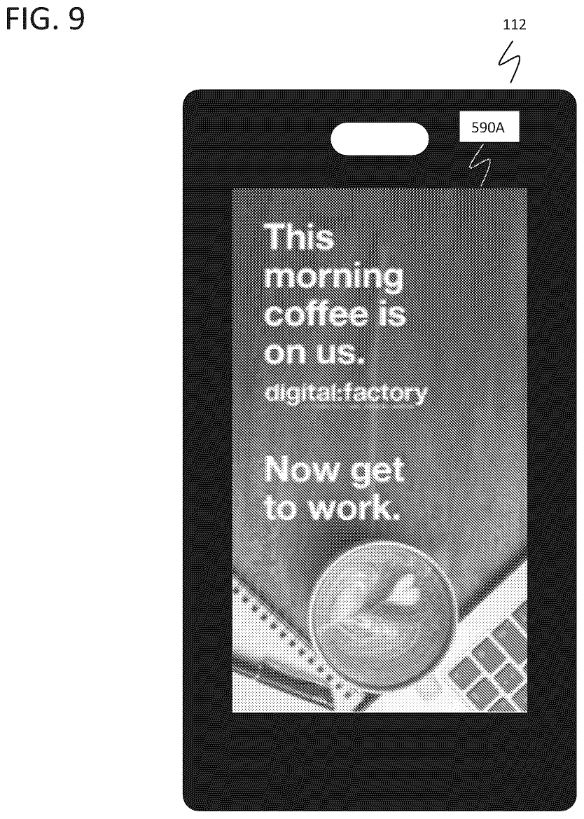

FIG. 9 illustrates a mobile device 112 of the end user 110 displaying the selected notification 590A in FIG. 7. In accordance to block 414 in FIG. 4A, the system selects a notification 590, from the plurality of notifications available for and associated with the microfence 510 that the end user has entered, based on the audience profile attributes for the audience profile associated with the end user and the content attributes associated with the notifications available for the microfence. Once the system selects the notification, the system 120 causes the end user's mobile device 112 to display the selected notification in accordance to block 416. In one embodiment, the notification may include one or more promotional offers (including but not limited to coupons, discounts, sample give away, and other offers) that are available to a customer to redeem or convert. In other embodiments, the notification may also include additional information about the promotional offer, such as the effective dates of the offer. FIG. 9 illustrates the notification on the end user's mobile device offering a free cup of coffee.

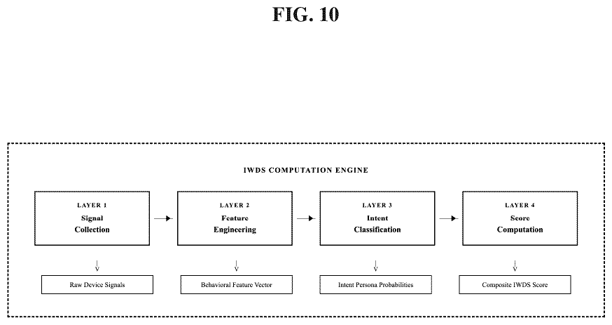

Referring now to FIG. 10, in one embodiment, the IWDS computation engine for improved detection of consumer intent with regard to a location comprises four principal processing layers arranged in a sequential pipeline: a Signal Collection Layer, a Feature Engineering Layer, an Intent Classification Layer, and a Score Computation Layer.

The Signal Collection Layer receives raw device signals from mobile computing devices present within a defined venue boundary. The Feature Engineering Layer transforms these raw signals into a structured behavioral feature vector. The Intent Classification Layer applies a trained classification model to the feature vector to produce a probability distribution across a set of intent persona categories. The Score Computation Layer combines the raw dwell duration with the classification output and a plurality of contextual adjustment factors to produce the final IWDS score.

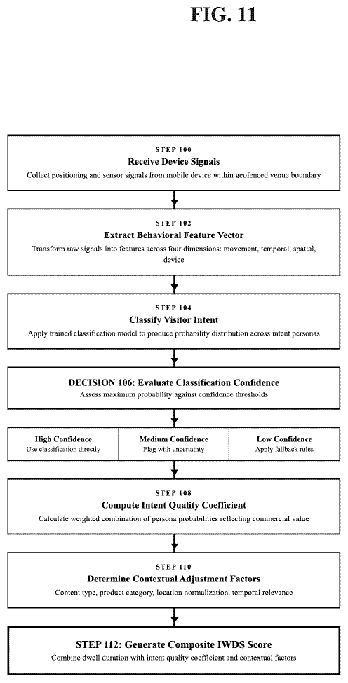

Referring now to FIG. 11 the method used by the IWDS can be elaborated. The Signal Collection Layer receives sensor inputs from one or more positioning technologies available on a mobile computing device. In preferred embodiments, signals may include but are not limited to: satellite-based positioning data (GPS/GNSS), wireless local area network signal characteristics (WiFi), short-range radio beacon signals (Bluetooth Low Energy), inertial measurement unit data (accelerometer, gyroscope), and barometric pressure readings.

In one embodiment, signals are collected by a software development kit (SDK) installed within a mobile application on the visitor's device. The SDK performs initial signal processing including noise filtering, temporal alignment, and privacy-preserving transformations before transmitting feature-level data to the processing infrastructure. Raw signal data is treated as ephemeral and is not persisted beyond the local device, consistent with a privacy-first architectural design.

The Feature Engineering Layer extracts a plurality of behavioral features from the collected signals. In preferred embodiments, features are organized across four principal signal dimensions:

Movement Patterns-Features derived from the spatial trajectory of the device, including velocity characteristics, trajectory complexity, directional variance, zone boundary crossings, stationary period detection, and spatial coverage of the venue area.

Temporal Patterns—Features derived from the timing characteristics of the visit relative to historical patterns, including time-of-day correlation, day-of-week patterns, visit frequency over a rolling window, regularity of visit timing, and duration distribution relative to personal historical norms.

Spatial Behavior—Features derived from the visitor's interaction with defined spatial zones within the venue, including entry point analysis, dwell distribution across commercial and non-commercial zones, engagement with high-value areas, proximity to restricted areas, and exit trajectory characteristics.

Device Characteristics—Features derived from the device's connectivity behavior and signal properties, including network auto-association patterns, signal stability metrics, in-application activity levels, and device presence outside normal operating hours.

Each signal dimension contributes a subset of the overall behavioral feature vector. The specific features extracted, their normalization methods, and their relative contributions to the classification model represent proprietary elements of the system's implementation. In one embodiment, features are normalized using statistical standardization methods prior to classification.

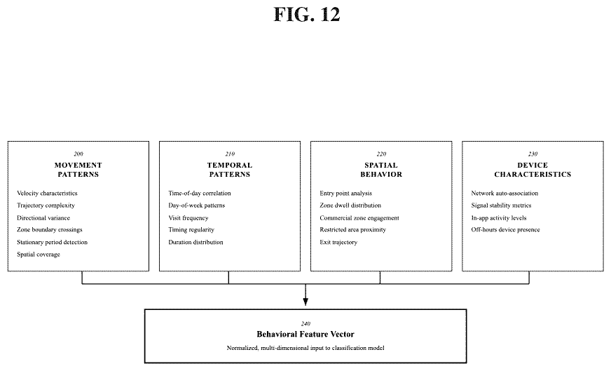

Referring now to FIG. 12, the Signal Dimensions are processed in the Intent Classification Layer. The Intent Classification Layer assigns each visit a probability distribution across a plurality of intent persona categories. In one embodiment, the system defines six intent persona categories:

High Intent—Visitor is actively evaluating products or services, engaging in comparison behavior, and exhibiting a high probability of commercial transaction.

Moderate Intent—Visitor is engaged in casual browsing or discovery behavior, with potential for conversion given appropriate engagement triggers.

Low Intent—Visitor is physically present but not meaningfully engaged with the commercial environment, such as waiting, sheltering, or socializing.

Employee—Visitor exhibits behavioral patterns consistent with a staff member performing regular duties, including consistent scheduling, restricted-area access, and repetitive daily patterns.

Transient—Visitor is present for a brief, purpose-limited interaction such as delivery, pickup, or pass-through transit.

Service Provider—Visitor is present for a non-customer business purpose such as vendor services, maintenance, or facility management.

In one embodiment the Classification Model comprises a multi-layer neural network trained on labeled visit data. The model receives the normalized behavioral feature vector as input and produces a probability distribution across the six intent persona categories as output. The output layer applies a softmax activation function such that the probabilities sum to unity.

The model architecture includes one or more hidden layers with nonlinear activation functions and regularization techniques to prevent overfitting. The specific architecture, including the number and size of hidden layers, activation functions, regularization parameters, and training hyperparameters, are implementation details that may be varied by those skilled in the art without departing from the scope of the invention.

Alternative embodiments may employ other classification approaches including, but not limited to, gradient-boosted decision trees, random forests, support vector machines, or ensemble methods combining multiple classification techniques.

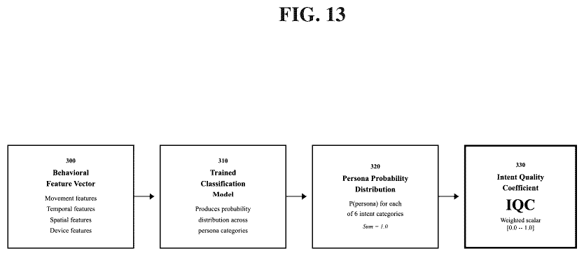

Referring now to FIG. 13, the Intent Classification Process develops an Intent Quality Coefficient by a sequence of steps transforming the classification output into a scalar value referred to as the Intent Quality Coefficient (IQC). The IQC is computed as a weighted combination of the persona probabilities, where each persona category is assigned a weight reflecting its relative commercial value. Personas representing genuine customer engagement receive higher weights, while personas representing non-customer presence receive lower weights or are excluded entirely.

The IQC is bounded within a normalized range, providing a continuous measure of engagement quality that reflects the relative mixture of intent signals present in the behavioral data. The specific weights assigned to each persona category are proprietary calibration parameters of the system.

The system evaluates the Classification Confidence of each classification based on the distribution of probabilities across persona categories. When the highest-probability persona exceeds a first confidence threshold, the classification is used directly. When the highest probability falls between a first and second threshold, the classification is used with an uncertainty indicator. When the highest probability falls below the second threshold, the system may apply fallback heuristic rules or exclude the visit from scoring.

The Score Computation Layer uses a Composite Score Methodology to generate the final IWDS by combining the raw dwell duration with the Intent Quality Coefficient and a plurality of contextual adjustment factors. In one embodiment, the composite score is computed as a multiplicative combination of the following components:

Raw Dwell Duration—The measured duration of the visit within the geofenced venue boundary, expressed in standardized time units.

Intent Quality Coefficient—The scalar representation of behavioral intent quality derived from the classification model output, as described in Section 4.4.3.

Content Type Factor—An adjustment factor reflecting the nature of the visitor's engagement, such as transactional, discovery, service-oriented, entertainment, task-oriented, social, or idle behavior.

Product Category Factor—An adjustment factor reflecting the type and consideration complexity of the goods or services associated with the engagement, accounting for the expected variation in dwell patterns across product categories.

Location Normalization Factor—An adjustment factor that normalizes the score across venues of different physical size, format, geographic context, and traffic volume, ensuring cross-venue comparability.

Temporal Relevance Factor—An adjustment factor reflecting the time-based relevance of the visit, including recency decay, peak-period weighting, seasonality adjustments, and promotional event context.

The multiplicative combination of these components produces a score in which high-quality, commercially relevant visits receive proportionally higher values than low-quality or non-customer visits, even when the raw dwell durations are comparable or when the low-quality visit exhibits a longer raw duration.

A content type factor is produced via Content Type Classification. The content type factor is determined by classifying the nature of the visitor's engagement within the venue. In one embodiment, the system recognizes a plurality of content types including transactional engagement, discovery and exploration, service consumption, entertainment, task completion, social activity, and idle waiting. The classification is based on the ratio of time spent in commercial versus non-commercial zones, the density of interaction events, the purposefulness of the visitor's path, and contextual information about the venue's primary function.

In certain embodiments, the content type factor is further adjusted based on the venue category, recognizing that the same type of engagement may carry different commercial significance in different venue contexts.

The Product Category Factor adjusts the score based on the type of goods or services associated with the visitor's engagement. The system recognizes that different product categories exhibit fundamentally different expected dwell patterns and commercial values. High-consideration categories, such as luxury goods, technology, or automotive, warrant longer dwell times and higher score adjustments than low-consideration categories such as everyday consumer goods.

In one embodiment, the product category is determined primarily by venue classification, supplemented by zone-level engagement analysis for multi-category venues. The product category factor is further modified by an assessment of the consideration complexity of the specific engagement, ranging from impulse purchases to complex evaluation decisions.

The Location Normalization factor ensures that IWDS scores are comparable across venues of different physical characteristics. In one embodiment, normalization accounts for venue physical size, product density, baseline traffic volume, venue format (such as standalone, mall-anchored, or urban storefront), and geographic context (such as urban, suburban, or rural setting). The normalization factor adjusts the score such that a visitor exhibiting identical engagement behavior at venues of different sizes and formats will produce comparable IWDS values.

Temporal Relevance Weighting uses a temporal relevance factor which adjusts the score based on time-related characteristics of the visit. In one embodiment, temporal adjustments include a recency decay function that assigns higher weight to more recent visits for real-time applications, a peak-period adjustment that reflects the higher commercial significance of visits during peak operating hours, and an event-context adjustment that accounts for promotional periods or special events that may alter normal engagement patterns.

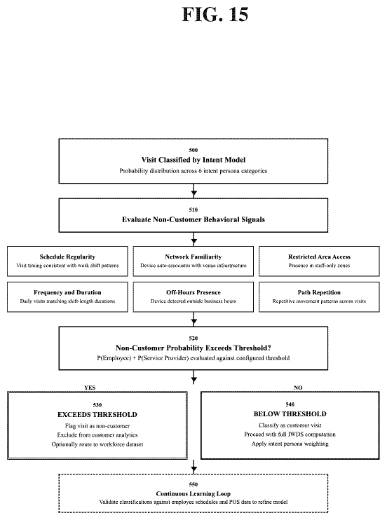

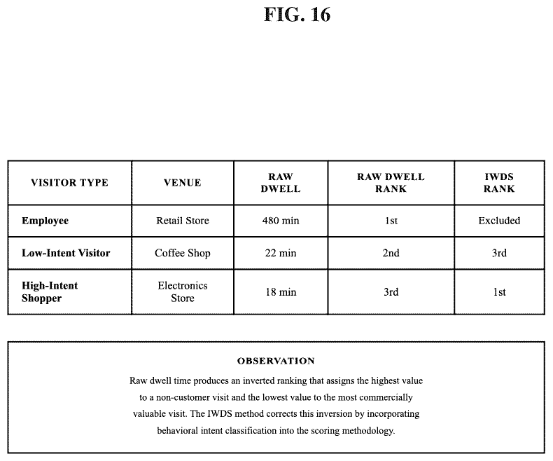

Referring now to FIGS. 15 and 16, a particular advantage of the present invention is Non-Customer Visitor Detection, namely the ability to identify and exclude non-customer visitors from customer-facing analytics. The intent classification model is trained to recognize behavioral patterns characteristic of employees, service providers, and transient visitors.

Employee detection relies on the combination of multiple behavioral signals including, but not limited to: highly regular visit timing patterns consistent with work schedules, device connectivity patterns indicating familiarity with venue network infrastructure, spatial behavior indicating access to or extended presence in restricted or staff-only areas, visit frequency and duration patterns consistent with shift-based work, and the presence of the device at the venue outside normal operating hours.

When the classification model assigns a probability exceeding a configured threshold to the employee persona, the visit is flagged for exclusion from customer analytics. The system may optionally maintain a separate employee analytics dataset for workforce management applications.

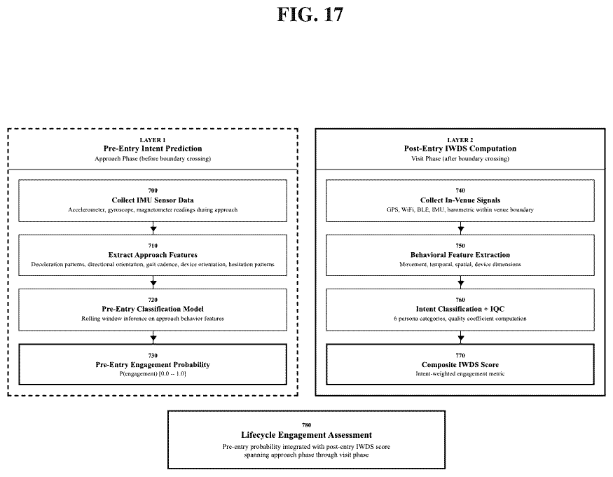

Referring now to FIG. 17, in a further aspect of the invention, the system provides Pre-Entry Intent Prediction, namely predicts visitor engagement probability prior to the visitor crossing the geofenced venue boundary. This pre-entry prediction capability extends the intent assessment to the approach phase of the visitor lifecycle, enabling earlier and more accurate engagement scoring.

The pre-entry prediction method uses Inertial Sensor Pattern Analysis which collects inertial measurement unit (IMU) data from the mobile computing device as the visitor approaches the venue boundary. In one embodiment, the IMU data comprises accelerometer readings capturing linear acceleration patterns, gyroscope readings capturing rotational velocity and orientation changes, and magnetometer readings capturing heading and directional intent. These three sensor streams are fused to produce a composite motion signature that characterizes the visitor's approach behavior.

The approach motion signature captures behavioral patterns that are predictive of engagement intent, including but not limited to: deceleration patterns indicative of intentional approach versus pass-through transit, directional orientation toward the venue entrance versus tangential path, gait cadence changes associated with transition from transit to browsing behavior, device orientation changes consistent with wayfinding or product awareness, and hesitation-acceleration patterns indicative of decision-making behavior.

A trained Pre-Entry Classification machine learning model receives the inertial sensor pattern features and produces a pre-entry engagement probability representing the likelihood that the approaching visitor will exhibit meaningful commercial engagement upon entry. The model is trained on labeled data correlating pre-entry sensor patterns with post-entry behavioral classifications, establishing a predictive link between approach behavior and in-venue intent.

In one embodiment, the pre-entry model operates on a rolling window of IMU data collected during the approach phase, producing updated probability estimates as additional sensor data becomes available. The model architecture and training methodology may be varied by those skilled in the art without departing from the scope of the invention.

The pre-entry engagement probability is integrated with the post-entry IWDS computation to provide a continuous intent assessment across the full visitor lifecycle. In one embodiment, the pre-entry prediction serves multiple functions: it provides an initial intent estimate that is refined by subsequent in-venue behavioral classification; it enables early-stage engagement triggers such as personalized messaging or staff alerting prior to or immediately upon entry; and it contributes to the overall confidence of the final IWDS score by providing an independent, temporally distinct signal of visitor intent.

The combination of pre-entry sensor pattern prediction with post-entry behavioral classification and composite scoring represents a novel two-layer intent assessment architecture in which the first layer predicts engagement before entry and the second layer classifies and scores engagement during the visit.

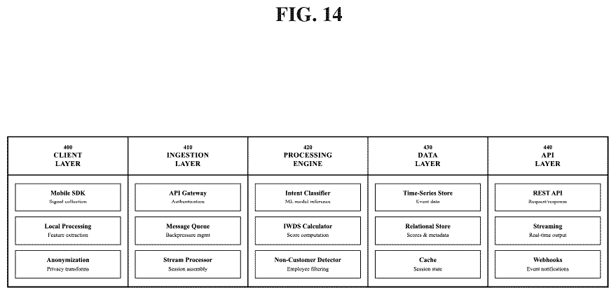

Referring now to FIG. 14, in one embodiment the Data Processing Architecture of the the system comprises a real-time data processing pipeline with the following principal components:

Client Layer 400—Mobile SDK installed on visitor devices performs signal collection, initial feature extraction, anonymization, and batch transmission of feature-level data to the processing infrastructure.

Ingestion Layer 410—Receives incoming feature data through an authenticated gateway, buffers events in a message queue for backpressure management, and performs real-time stream processing including session assembly and temporal alignment.

Processing Engine 420—Executes the intent classification model inference, computes the IWDS score with all component factors, and performs non-customer detection. This layer implements the core computational method described in Section 4.

Data Layer 430—Persists computed scores, classification results, and session state across purpose-built storage systems optimized for time-series data, relational queries, real-time caching, and model artifact management.

API Layer 440—Provides access to IWDS results through synchronous request-response interfaces, real-time streaming connections, event-driven notifications, and partner integration endpoints.

The processing pipeline is designed to compute IWDS scores with low latency following visit completion, enabling real-time applications including dynamic advertising optimization and live venue analytics.

The system is designed with a privacy-first architecture. In one embodiment, device identifiers are transformed using one-way cryptographic hash functions with rotating salts, preventing re-identification of individual visitors. Raw positioning signals are processed locally on the device and are not transmitted to the processing infrastructure; only derived behavioral features are uploaded.

The system provides mechanisms for data subject rights including programmatic deletion of all data associated with a device identifier. Data retention policies define separate retention periods for raw event data and computed scores. The system supports regional data processing to comply with data residency requirements.

The effectiveness of the IWDS system is validated through correlation analysis between computed IWDS scores and actual commercial outcomes. In one embodiment, validation is performed by comparing IWDS-based visitor segmentation against point-of-sale transaction data, demonstrating that high-IWDS visitors convert at significantly higher rates than visitors identified solely by raw dwell time thresholds.

In testing across multiple venue types encompassing retail, quick-service restaurant, and entertainment categories, the IWDS method demonstrated statistically significant improvement in conversion prediction accuracy compared to raw dwell time segmentation. The intent classification model achieved high recall rates for non-customer detection when validated against known employee schedules, and the composite IWDS scores exhibited meaningful positive correlation with actual transaction events that materially exceeded the correlation achieved by raw dwell time alone.

Additional validation includes comparative A/B testing of IWDS-based targeting versus raw-dwell-based targeting for advertising applications, demonstrating measurably improved return on advertising spend when visit quality is incorporated into the attribution methodology.

The pre-entry prediction capability was validated by correlating pre-entry engagement probabilities with post-entry behavioral classifications, demonstrating that inertial sensor patterns during the approach phase carry statistically significant predictive information about subsequent in-venue engagement quality.

While specific embodiments have been described, the invention is not limited to the particular configurations disclosed. Alternative embodiments may include:

Application of the method to outdoor commercial environments such as shopping districts, entertainment districts, or mixed-use developments, rather than individual enclosed venues.

Integration with point-of-sale systems to provide closed-loop attribution, wherein the IWDS computed during a visit is correlated with subsequent transaction data to refine model accuracy.

Extension of the classification model to include additional intent persona categories specific to particular industry verticals, such as healthcare, hospitality, or event management.

Use of the IWDS methodology in aggregate to produce venue-level quality metrics, enabling comparison of engagement quality across locations within a portfolio.

Application of transfer learning techniques to adapt a general-purpose intent classification model to specific venue types with limited labeled training data.

Real-time adjustment of the classification model based on streaming behavioral data, enabling adaptive scoring that responds to changes in venue characteristics or visitor demographics over time.

Various other modifications may be made without departing from the spirit and scope of the invention. For example, various forms of the flows shown above may be used, with steps re-ordered, added, or removed. The following claims in its broader aspects is therefore not limited to the specific details, representative system and method, and illustrative example shown and described. Accordingly, other embodiments are within the scope of the following claims.

1. A computer-implemented method for generating a composite engagement score for a visit to a physical venue, the method comprising:
(a) receiving, by a processor, a plurality of device signals from a mobile computing device present within a geofenced boundary of the physical venue during a visit period;
(b) extracting, by the processor, a behavioral feature vector from the plurality of device signals, the behavioral feature vector comprising features across a plurality of signal dimensions including movement patterns, temporal patterns, spatial behavior patterns, and device connectivity characteristics;
(c) applying, by the processor, a trained classification model to the behavioral feature vector to produce a probability distribution across a plurality of intent persona categories, the intent persona categories comprising at least a high-intent category, a low-intent category, and a non-customer category;
(d) computing, by the processor, an intent quality coefficient as a weighted combination of the probability values across the intent persona categories;
(e) determining, by the processor, one or more contextual adjustment factors based on at least one of: the nature of the visitor's engagement, the characteristics of the physical venue, and the temporal context of the visit; and
(f) generating, by the processor, a composite engagement score by combining the raw dwell duration of the visit with the intent quality coefficient and the one or more contextual adjustment factors.

2. The method of claim 1, wherein the plurality of intent persona categories further comprises an employee category, a transient category, and a service provider category.

3. The method of claim 1, wherein the movement pattern features comprise at least one of: velocity variance, trajectory complexity, zone transition count, stationary period frequency, directional variance, and spatial coverage ratio.

4. The method of claim 1, wherein computing the intent quality coefficient comprises assigning a weight to each intent persona category reflecting its relative commercial value, multiplying each weight by the corresponding probability value, and summing the weighted values.

5. The method of claim 1, wherein the one or more contextual adjustment factors comprise a content type factor reflecting the nature of the visitor's engagement within the venue.

6. The method of claim 5, wherein the content type factor is determined based on at least one of: the ratio of time spent in commercial versus non-commercial zones, the density of interaction events, and the purposefulness of the visitor's path.

7. The method of claim 1, wherein the one or more contextual adjustment factors comprise a product category factor reflecting the type and consideration complexity of goods or services associated with the engagement.

8. The method of claim 1, wherein the one or more contextual adjustment factors comprise a location normalization factor that adjusts the composite score based on at least one of: venue physical size, venue format, geographic context, and baseline traffic volume.

9. The method of claim 1, wherein the one or more contextual adjustment factors comprise a temporal relevance factor that adjusts the composite score based on at least one of: visit recency, peak-period timing, and promotional event context.

10. The method of claim 1, further comprising: identifying a visit as a non-customer visit when the probability assigned to the non-customer category exceeds a configured threshold, and excluding the visit from customer-facing analytics.

11. The method of claim 10, wherein identifying a non-customer visit comprises detecting behavioral patterns indicative of an employee, including at least one of: regular visit timing consistent with work schedules, device auto-association with venue network infrastructure, spatial behavior indicating access to restricted areas, and device presence at the venue outside normal operating hours.

12. The method of claim 1, wherein generating the composite engagement score comprises applying the intent quality coefficient and each contextual adjustment factor as scaling operations to the raw dwell duration.

13. The method of claim 1, further comprising: evaluating a confidence level of the classification based on the maximum probability value in the probability distribution, and applying the classification directly when the confidence exceeds a first threshold, applying the classification with an uncertainty indicator when the confidence falls between the first threshold and a second threshold, and applying fallback heuristic rules when the confidence falls below the second threshold.

14. A system for generating composite engagement scores for visits to physical venues, the system comprising:
a signal collection module configured to receive device signals from mobile computing devices present within geofenced venue boundaries;
a feature engineering module configured to extract behavioral feature vectors from the device signals across a plurality of signal dimensions;
an intent classification module comprising a trained machine learning model configured to produce probability distributions across a plurality of intent persona categories;
a score computation module configured to generate composite engagement scores by combining raw dwell durations with intent quality coefficients derived from the classification output and one or more contextual adjustment factors; and
a non-customer detection module configured to identify and flag visits exhibiting behavioral patterns consistent with employees, service providers, or transient visitors.

15. The system of claim 14, wherein the signal collection module comprises a software development kit installable on mobile computing devices, the SDK configured to perform local feature extraction and privacy-preserving transformations prior to transmitting feature-level data to the processing infrastructure.

16. The system of claim 14, further comprising a real-time processing pipeline configured to compute composite engagement scores with low latency following visit completion.

17. The system of claim 14, wherein the contextual adjustment factors comprise a content type factor, a product category factor, a location normalization factor, and a temporal relevance factor.

18. The system of claim 14, wherein the score computation module generates the composite engagement score by applying the intent quality coefficient and the contextual adjustment factors as scaling operations to the raw dwell duration.

19. A non-transitory computer-readable medium storing instructions that, when executed by one or more processors, cause the processors to:
receive device signals from a mobile computing device present within a geofenced boundary of a physical venue;
extract a behavioral feature vector from the device signals comprising features across movement pattern, temporal pattern, spatial behavior, and device connectivity dimensions;
classify the visit into one of a plurality of intent persona categories using a trained machine learning model;
compute an intent quality coefficient from the classification output;
determine contextual adjustment factors based on engagement characteristics, venue characteristics, and temporal context; and
generate a composite engagement score by combining the raw dwell duration with the intent quality coefficient and the contextual adjustment factors.

20. The non-transitory computer-readable medium of claim 19, wherein the instructions further cause the processors to identify visits by non-customer visitors based on behavioral pattern recognition and exclude identified non-customer visits from customer-facing analytics.

21. (canceled)

22. (canceled)

23. (canceled)

24. (canceled)
